(19) United States
(12) Patent Application Publication
(10) Pub. No.: US 2022/0252476 A1
(43) Pub. Date: Aug. 11, 2022

(54) WIRELESS PRESSURE SENSOR AND ASSOCIATED SWIMMING-POOL MONITORING DEVICE

(71) Applicant: GROUPE WATERAIR, Seppois-Le-Bas (FR)

(72) Inventors: Thierry Steinbauer, Giromagny (FR); Wajdi Heni, Mulhouse (FR)

(21) Appl. No.: 17/584,082

(22) Filed: Jan. 25, 2022

(30) Foreign Application Priority Data
Feb. 5, 2021 (FR) 2101126

(51) Int. Cl. G01L 19/08; B01D 37/04; G01L 19/12; G01L 9/00

(52) U.S. Cl. CPC G01L 19/086; G01L 9/00; G01L 19/12; B01D 37/046

(57) ABSTRACT

A wireless pressure sensor of a swimming pool filtration system includes a pressure switch, a communication unit, an energy storage element, a memory for recording multiple consecutive measurements, and an analysis device. The analysis device is configured to detect a critical situation if one or more current measurements exceed a critical value and/or if the pressure difference between a current measurement and the last measurement recorded in the memory is greater than a predetermined value. The communication unit is configured to send, upon expiration of a transmission period, the measurements stored in said memory. The communication unit also is configured to transmit the measurements stored in the memory before the expiration of the transmission period when the analysis device detects a critical situation.

### TECHNICAL FIELD

The present invention relates to the field of swimming pool monitoring and more particularly to the control of the change of the pressure of a swimming pool filtration system.

The invention relates more particularly to detecting the needs to perform an operation on the filtration system, for example, when the skimmer baskets are full or when the filter medium needs cleaning. A particularly advantageous application of the invention is to improve the reliability and the safety of a filtration system of a swimming pool.

### BACKGROUND

Conventionally, a swimming pool comprises a filtration system for forcing a movement of the water and for filtering the water to eliminate undesirable compounds from it. For this purpose, a swimming pool is generally provided with one or more skimmers for suctioning water on the surface of the swimming pool so that the larger impurities present on the surface of the water are collected in baskets inserted in the skimmer(s). The water is suctioned into these skimmers by the suction force of a pump connected to a filter incorporating a filter medium. In order to filter finer impurities, the water suctioned into the skimmers passes through the filter before being reinjected into the swimming pool through discharge nozzles. In addition, the filtration system can also comprise various control and treatment means such as a pH regulator or an electrolyzer for chemically treating the water passing through the filtration system.

In a filtration system, the pump is a central element generally dimensioned in order to circulate a quarter of the volume of water of the swimming pool per hour. Thus, the larger the swimming pools are the more powerful and thus the more expensive the pumps of the filtration system can be. During treatment phases, it is then often necessary to manipulate multiple sensitive valves, including a 6-way valve conventionally used for regulating the connections between the discharge nozzles, the skimmers, the pump, the filter, and a drain outlet.

Taking into account the number of valves to be manipulated to perform the different treatments, the user risks activating the pump in a non-recommended position of the valves and thus compromising the effectiveness of the filtration and of the physicochemical treatment of the water of the swimming pool or even damaging the filtration system. There are solutions for automatically detecting a manipulation error in the valves of the filtration system or a need for cleaning the filter medium of the filter.

Conventionally, these solutions use a pressure sensor mounted on the filter. Several pressure sensor types exist: the wired pressure sensors and the wireless pressure sensors. A wired pressure sensor is a sensor the supply of which and/or the data transmission of which is carried out by means of a wired connector generally connected to an electric meter and/or a control panel of the filtration system. These pressure sensors are notably used when one wishes to obtain a very precise measurement, since it is possible to use energy-intensive pressure switches for measuring the pressure inside the filter.

Based on these measurements of the pressure switch, the wired pressure sensors conventionally incorporate data processing for interpreting the measurements in order to detect maintenance needs on the filtration system and inform a user. For this purpose, the wired pressure sensors can also incorporate communication means, for example, a wired network connection or a wireless network connection. In order to inform the user, the wired sensor can also house an accessible Web interface using the router of an individual as gateway so that the wired sensor can access the internet.

With these different functionalities and the precision of the pressure switches conventionally used in these wired sensors, a large electrical energy supply is often necessary. Thus, these wired pressure sensors often require a relatively complex installation phase, since, for example, an outlet is appropriately added at the site of the electrical counter.

As alternative to these wired pressure sensors, wireless pressure sensors also exist, which incorporate an energy storage element and a wireless communication unit for transmitting the measurements carried out by a pressure switch. In this wireless type of pressure sensor, the pressure switch generally corresponds to a less precise pressure switch than those used for the wired pressure sensors but exhibiting a lower consumption.

In addition, these wireless pressure sensors are conventionally connected to a remote control unit intended to house the analysis functions via a network gateway for transmission of the measurements acquired by the pressure switch.

Regardless of which technology is used for the pressure sensor, it is possible to use this pressure sensor in order to indicate to a user when the pressure present in the filtration system reaches a predetermined threshold so as to indicate to the user a need for cleaning the filter medium. In addition, it is also possible to detect an incorrect position of a valve after an intervention on the filtration system.

With the wireless pressure sensors, it is currently difficult to provide these two types of information while at the same time guaranteeing a long duration of operation of the energy storage element.

In fact, in order to detect that a predetermined pressure threshold has been exceeded using the low-consumption pressure switches used in the wireless pressure sensor, it is necessary to carry out multiple consecutive measurements in order to eliminate the measurement artifacts or to detect a specific pressure profile.

Thus, conventionally one must consider at least ten measurements before being assured that the average pressure in these ten measurements actually exceeds the predetermined pressure threshold in order to advise a user to clean the filter medium. These ten measurements can be carried out and transmitted at relatively long time intervals in order to avoid discharging the energy storage element of the wireless pressure sensors. Typically, it is possible to carry out a measurement every 10 or 20 minutes in order to effectively detect the need for cleaning a filter medium. With these information transmission strategies, it is possible to use an energy storage element having a sufficient charge capacity for the wireless pressure sensor to exhibit autonomy for a whole season. Thus, the user would only need to replace or recharge the energy storage element once per season.

In order to then detect the incorrect positioning of a valve after an intervention on the filtration system, it is necessary to be much more reactive in order to protect the pump and it is necessary to transmit information every 30 seconds or every minute in order to inform the user as early as possible.

As a result of the technical choice of such frequent transmission of information, the energy storage element would have to be much larger and it would also be necessary to replace it much more often during the course of the season in order to guarantee the autonomy of the wireless pressure sensor.

Thus, for reasons relating to costs and operating constraints, the known wireless pressure sensors do not enable one to control a large number of malfunctions that can appear in the filtration system and conventionally they aim to control only the average pressure of the filtration system in order to inform the user of a need for cleaning the filter medium.

The technical problem of the invention is thus to obtain a wireless pressure sensor for detecting a larger number of malfunctions that can occur in a swimming pool filtration system while at the same time exhibiting an acceptable autonomy.

### SUMMARY OF THE DISCLOSURE

In order to address this technical problem, the invention proposes using a wireless pressure sensor wherein a part for the analysis, conventionally incorporated in the remote control unit, is incorporated in the wireless pressure sensor. This analysis device, incorporated in the wireless pressure sensor, aims to detect directly at the site of the wireless pressure sensor the appearance of a critical event requiring immediate or near-immediate treatment, such as overshooting a critical value. The detection of the critical event triggers the immediate transmission of the measurements stored in the sensor to the remote control unit outside of the normal transmission period of the measurements. This detection occurs by means of dedicated algorithms embedded in the wireless pressure sensor. Thus, it is possible to transmit measurements with a very long transmission period and at particular times reduce this transmission period when a critical situation is detected.

Moreover, the use of this analysis device in the wireless pressure sensor also enables one to store consecutive measurements in order to transmit them together when the communication unit is periodically activated, or at particular times at the time of a critical situation. The remote control unit can thus analyze precise data since they result from a set of measurements transmitted during each transmission period instead of transmitting a single measurement per transmission period.

The invention is based on an observation according to which the consumption of this analysis device embedded in the wireless pressure sensor is clearly less than the gain obtained by the limitation of the activation of the wireless connection means, so that the consumption of the wireless pressure sensor is low while at the same time nevertheless enabling the control of multiple malfunctions. Using an energy storage element having a conventional charge capacity it is thus possible to obtain a wireless pressure sensor with satisfactory autonomy, for example, for substantially for nine to twelve months.

For this purpose, according to a first aspect, the invention relates to a wireless pressure sensor of a swimming pool filtration system, said wireless pressure sensor comprising:
a pressure switch configured to measure a pressure and/or a depression;
a communication unit comprising wireless communication means for transmitting the measurements of said pressure switch; and
an energy storage element configured to power said communication unit.

The invention is characterized in that said communication unit also comprises:
a memory for recording multiple consecutive measurements; and
an analysis device configured to detect a critical situation if one or more current measurements exceed a critical pressure value or a critical depression value and/or if the pressure difference between a current measurement and the last measurement recorded in the memory is greater than a predetermined value;
said communication unit being configured to send, upon expiration of a transmission period, the measurements stored in said memory;
said communication unit also being configured to transmit the measurements stored in said memory before the expiration of said transmission period when said analysis device detects a critical situation.

The invention thus enables one to transmit precise measurements to a remote control unit, since these measurements can be multiple during the entire transmission period. For example, a measurement can be carried out with a refresh period between 1 second and 10 minutes, while the transmission can be between 10 and 120 minutes.

Moreover, this analysis device embedded in the wireless pressure sensor can also limit the recording in the memory by measuring the pressure difference between the current measurement and a preceding measurement.

When this difference is less than a recording threshold value, no pressure value is added in the memory, so that, at the end of the transmission period, the number of information items to be transmitted is limited, thus further reducing the consumption and the number of data to be stored on the remote data server. The remote control unit can then reconstitute the missing information, for example, if each measurement transmitted by the wireless pressure sensor is time stamped. In addition, in order to also reduce the consumption of the wireless pressure sensor, these wireless communication means preferably use the Lora communication protocol for transmitting the measurements to the control unit.

According to a second aspect, the invention also relates to a swimming pool monitoring device comprising:
a wireless pressure sensor according to the first aspect of the invention, mounted on a filter or a pipe of a filtration unit;
a remote control unit, connected with said wireless pressure sensor and the internet network, configured to receive and interpret said measurements of said wireless pressure sensor;
a network gateway ensuring the communication of the data between said wireless pressure sensor and said remote control unit; and
a mobile application connected with said control unit so as to transmit the interpretations of said control unit to a user.

The monitoring device thus makes it possible to interpret the measurements of the wireless pressure sensor and to transmit these interpretations to a user by means of a mobile application. In addition, the interpretations can also be transmitted via an internet page housed on the control unit. Thus, the use of this control unit enables one to limit the consumption of the wireless pressure sensor by putting the most energy-intensive part of the treatments outside of the wireless pressure sensor.

Among the possible interpretations of this remote control unit, it can interpret:
a closed discharge valve when said control unit receives at least two consecutive measurements greater than or equal to a maximum operating threshold value;
a low water level or a blocked skimmer flap when the measurements obtained during a predetermined time period exhibit an oscillating profile;
a clogged prefilter or skimmer basket when the measurements obtained during a predetermined time period exhibit a pressure decrease profile or a depression increase profile;
a closed suction valve or a startup problem of the filtration pump in a time slot of expected operation, and
a startup of the filtration pump outside of a time slot of expected operation, for example, during a manual operation without prior information on the monitoring device.

For example, said oscillating profile can be detected by calculating the pressure derivatives between two consecutive measurements obtained during said predetermined duration and by identifying the oscillating profile when a predetermined number of derivatives exhibit sign reversal and a difference greater than a threshold value.

Said decrease profile can also be detected by calculating the pressure derivatives between two consecutive measurements obtained during said predetermined duration and by identifying the decrease profile when a predetermined number of derivatives is less than a threshold value.

In addition, the remote control unit can also determine a level of clogging of a filter medium by determining the ratio between a smoothed average pressure value, calculated over a set of measurements obtained during a predetermined duration, and a maximum service pressure.

Based on this average pressure value, the control unit can also interpret a need for cleaning the filter medium when said average pressure value is greater than said maximum service pressure or a future need for cleaning the filter medium when said average pressure value is greater than a predetermined percentage of said maximum service pressure.

According to the embodiments of the invention, the monitoring device can comprise a control box of the filtration pump. In this case, the control unit can be configured to command the control box to cut the power supply to the filtration pump in case of a confirmed risk to the filtration system identified by said control unit on the basis of the measurements provided by the pressure sensor.

The control unit can also be configured to interpret a closed suction valve or a startup problem of a filtration pump if at least two consecutive measurements provided by the pressure sensor are less than an operating threshold value and if the status of said control box indicates that it is operating.

In addition, said control unit can be configured to interpret that the filtration pump has started, whereas the control box did not issue the command to that effect, if at least two consecutive measurements provided by the pressure sensor are greater than the operating threshold value and if the status of the control box indicates that it is not operating.

In certain swimming pool filtration units, the depressions generated by the filtration pump can create periodic oscillations on the pressure measured by the wireless pressure sensor according to the invention and disturb the measurements or the interpretation.

In order to remedy this problem, it is possible to digitally process the measurement signal of the pressure sensor, for example, by carrying out the acquisition of each measurement by averaging multiple signals coming from the wireless pressure sensor.

As a variant, it is possible to treat the periodic oscillations of the measured pressure by the mechanical means. In this embodiment, said device preferably comprises a buffer chamber mounted between the wireless pressure sensor and the filter or the pipe of the filtration unit.

This buffer chamber, for example, filled with air, makes it possible to smooth the measurements acquired by the wireless pressure sensor and to limit the disturbances associated with the depressions generated by the filtration pump.

### BRIEF DESCRIPTION OF THE DRAWINGS

The invention will be clearly understood upon reading the following description, the details of which are given only as examples, and which is developed in connection with the appended figures in which identical reference numerals refer to identical elements:

FIG. 1 illustrates a diagrammatic cross-sectional view of a wireless pressure sensor according to a first embodiment of the invention;

FIG. 2 illustrates a diagrammatic representation of a swimming pool monitoring device incorporating the wireless pressure sensor of FIG. 1;

FIG. 3 illustrates a flow chart of the steps of analyses of the control box of the device of FIG. 2;

FIG. 4 illustrates a first representation with respect to time of the change of the pressure, representative of a clogged skimmer basket, for a characteristic period;

FIG. 5 illustrates a representation with respect to time of the pressure derivative for the measurements of FIG. 4;

FIG. 6 illustrates a second representation with respect to time of the change of the pressure, representative of a low water level, for a characteristic period;

FIG. 7 illustrates a representation with respect to time of the pressure derivative for the measurements of FIG. 6;

FIG. 8 illustrates a third representation with respect to time of the change of the pressure, representative of a stopping of a filtration pump, for a characteristic period;

FIG. 9 illustrates a representation with respect to time of the pressure derivative for the measurements of FIG. 8;

FIG. 10 illustrates a diagrammatic cross-sectional view of a wireless pressure sensor according to a second embodiment of the invention;

FIG. 11 illustrates a representation with respect to time of the change of the pressure in the presence of periodic oscillation; and

FIG. 12 illustrates a representation with respect to time of the change of the pressure in the presence of periodic oscillations and a buffer chamber.

### DETAILED DESCRIPTION

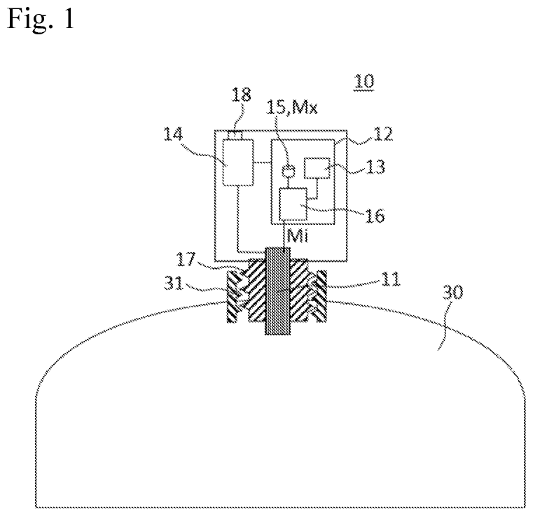

FIG. 1 illustrates a swimming pool filter 30 on which a wireless pressure sensor 10 according to a first embodiment of the invention is mounted and referred to as sensor 10 in the continuation of the description. More precisely, the upper portion of the filter 30 is provided with fastening means 31 conventionally intended to receive a manometer. In the example of FIG. 1, the manometer has been replaced by the sensor 10 using the internal threading of the fastening means 31 intended to fasten the manometer.

Thus, in the lower portion, the sensor 10 has fastening means 17 with an external threading matching the internal threading of the fastening means 31 of the filter 30.

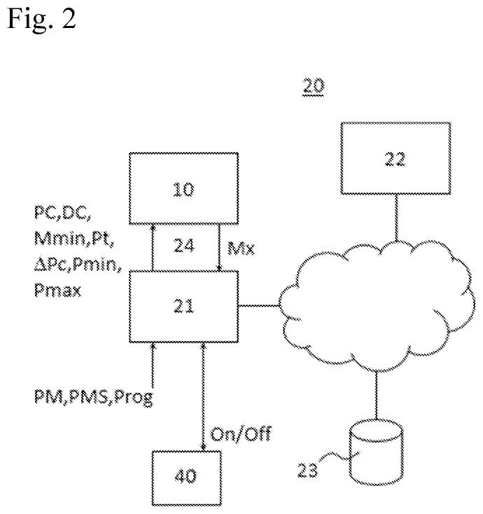

Inside the fastening means 17, the sensor 10 has a pressure switch 11 for sensing the pressure and/or the depression inside the filter 30. The current measurements Mi sensed by the pressure switch 11 are transmitted to a communication unit 12 incorporating an analysis device 16 for detecting whether the measurements Mx stored in a memory 15 should be immediately transmitted or not to a remote control unit 21 (see FIG. 2) via a network gateway 24.

For this purpose, the analysis device 16 compares each new current measurement Mi with one or more critical pressure values PC or critical depression values DC. If the current measurement Mi exceeds at least one of these critical values and/or if the pressure difference ΔPc between the current measurement Mi and the last measurement Mx recorded in the memory 15 is greater than a predetermined threshold value, then the measurements Mx stored in the memory 15 are immediately transmitted to the control unit 21 via the network gateway 24.

In the case to the contrary, the current measurement Mi is recorded after the measurements Mx previously stored in the memory 15. After a predetermined transmission period Pt, typically after a period of between, for example, 10 and 120 minutes, the analysis device 16 commands the transmission of all the measurements Mx stored in the memory 15 and the erasing of these measurements Mx.

In the case of a search for a pressure difference ΔPc between the current measurement Mi and the last measurement Mx recorded in the memory 15, the predetermined threshold value can correspond to a percentage of the useful pressure range of the filtration system. For example, for a pump delivering a maximum pressure PM of 1 bar, the useful pressure of the filtration system, referred to as maximum service pressure PMS, can be set, for example, at between 0.90 and 0.95 bar, or a percentage between 90 and 95% of the maximum pressure PM delivered by the pump. And the predetermined threshold value, referred to as maximum operating threshold value Pmax, can be set, for example, at at least 0.95 bar, or a percentage greater than or equal to 95% of the maximum pressure PM delivered by the pump. The maximum pressure PM delivered by the pump is thus used as reference value. It is determined by calibration when the discharge valve(s) is/are closed and the flow is zero.

In order to transmit the measurements Mx, the communication unit 12 also incorporates wireless communication means 13. The wireless communication means 13 can, for example, use the Lora network. In a variant, the communication network used by the wireless communication means 13 can correspond to the Wi-Fi or Bluetooth network.

The communication unit 12 can correspond to an electronic card, and the analysis device 16 can be implemented on a microcontroller with a very low consumption.

In addition to the adjustment of the transmission period Pt, the analysis device 16 can also decide whether or not a current measurement Mi should be stored. For example, the analysis device 16 can calculate the difference between a current measurement Mi and a preceding measurement, and, if the difference between these two measurements is less than a recording threshold value Mmin, the analysis device 16 inhibits the recording of this measurement Mi in the memory 15. The recording threshold value Mmin can correspond to a few millibars.

This embodiment makes it possible to limit the number of measurements Mx transmitted by the wireless communication means 13 when the pressure in the filter 30 is substantially stable.

Thus, when the measurements Mx are transmitted to the control unit 21, said control unit can receive a portion of the measurements actually performed during the transmission period Pt.

For example, the transmission period Pt can be between 10 and 120 minutes, while a measurement Mi can typically be obtained every minute or less depending on the case. For example, the refresh period of the measurements of the pressure switch 11 can be between 1 second and 10 minutes.

In order to power the communication unit 12 and optionally the pressure switch 11, an energy storage element 14 is incorporated in the sensor 10. For example, an energy storage element 14 can correspond to an accumulator or to battery cells. An interface 18 is preferably arranged in the sensor 10 in order to enable one to recharge the battery or the battery cells.

The sensor 10 is intended to be incorporated in a monitoring device 20 as illustrated in FIG. 2. More particularly, this sensor 10 intended to communicate with a remote control unit 21 connected by wire to an electrical network and connected wirelessly with the wireless communication means 13 of the sensor 10 via a network gateway 24. Multiple information items can thus be exchanged between the sensor 10 and the control unit 21, notably the set of the measurements Mx transmitted periodically or at particular times by the sensor 10. The mobile application 22 and/or the control unit 21 can communicate with the sensor 10 in order to modify the critical detection rules of pressure PC and of depression DC, the pressure difference ΔPc, as well as the transmission period Pt or also the recording threshold value Mmin, the maximum operating threshold value Pmax, the minimum operating threshold value Pmin, and the maximum service pressure PMS.

In addition to the wireless connection between the control unit 21 and the sensor 10 via the network gateway 24, the control unit 21 is also connected to the internet network, for example, by means of a Wi-Fi connection with a router or a wired connection of RJ45 type. This internet network enables a user to receive the interpretations of the control unit 21 via a mobile application 22 or an internet page. For example, an internet page can be housed on the control unit 21. Via the mobile application 22 or the internet page, the user can consult all the interpretations carried out by the control unit 21, and if the user has the appropriate rights he/she can adjust multiple parameters, notably the critical values PC, DC, the pressure difference ΔPc, the transmission period Pt, or also the maximum service pressure PMS beyond which his/her filter 30 should be cleaned, the recording threshold value Mmin, the maximum operating threshold value Pmax, and the minimum operating threshold value Pmin. Preferably, the adjustment of these values is administered by the manufacturer of the swimming pool and/or of the monitoring device.

The connection to the internet network also makes it possible to connect a support server 23 to the control unit 21. This support server 23 can be intended to update the different software present in the sensor 10 or the control unit 21.

In addition, this support server 23 can be used for receiving all the measurements Mx and all the interpretations carried out by multiple control units 21 of multiple different monitoring devices 20, in order to improve the malfunction detection algorithms.

For example, a malfunction detection algorithm implemented on a control unit 21 is illustrated in FIG. 3.

After reception of the measurements Mx, a first step 50 determines whether the transmission duration corresponds to the predetermined transmission period Pt. If this is not the case, the sensor 10 has detected a critical situation. Step 51 aims to verify whether at least two most recent consecutive measurements are greater than or equal to the maximum operating threshold value Pmax. If this is the case, a message 60 can be transmitted to the user via the mobile application 22 indicating that a discharge valve is closed.

The maximum operating threshold value Pmax can correspond to an adjustable percentage of the maximum pressure PM delivered by the pump, which can be greater than or equal to 95% of PM, while the maximum service pressure PMS can correspond to an adjustable percentage of the maximum pressure PM delivered by the pump, which can be adjusted to between 90 and 95% of PM. For example, the maximum operating threshold value Pmax and/or the maximum service pressure PMS can be adjusted at the site of the support server 23.

The user can thus act very rapidly in order to stop the pump and search for the closed discharge valve before reactivating the filtration system. The monitoring device 20 can also decide by itself to stop the filtration pump via a control box 40 in order to secure the filtration system, according to a decision scenario defined by the user.

This control box 40 is then incorporated in the monitoring device 20 as illustrated in FIG. 2.

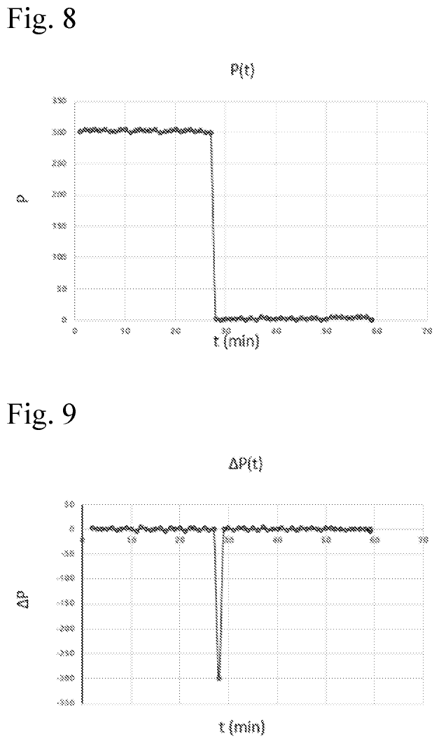

After this step 51 of searching for a malfunction on a discharge valve, a step 52 aims to analyze the running/stopped status ON/OFF of the control box 40 of the pump in a time slot of expected operation Prog. For this purpose, the time slot of expected operation Prog of the filter 30 is recorded in the control unit 21 and said control unit, in step 52 compares the pressure in the filter 30 with an expected pressure in the recorded time slots of operation of the pump. The startup or the stopping of the filtration pump can be detected by means of the change of the pressure as illustrated in FIGS. 8 and 9.

If at least two consecutive measurements are less than a minimum operating threshold value Pmin in a time slot of expected operation Prog and if the status of said control box 40 indicates that it is operating ON, a message 61 can be transmitted to the user via the mobile application 22 in order to indicate that a suction valve is closed or a startup problem of the filtration pump. This problem is common after an intervention performed if the user forgot to open a suction valve or if he forgot that a pump management switch is in stopped position.

The minimum operating threshold value Pmin can correspond to an adjustable percentage of the static pressure of the filtration system, that is to say the pressure measured when the pump of the filtration system is stopped. For example, the minimum operating threshold value Pmin can be set at the support server 23 to a value less than or equal to 50 mbars, or a percentage less than or equal to 5% of this static pressure. In addition, if at least two consecutive measurements Mx are greater than the minimum operating threshold value Pmin and if the status of the control box 40 indicates that it is not operating OFF, a message 61′ can be transmitted to the user via the mobile application 22 in order to indicate that the filtration pump has started whereas the control box 40 did not issue the command to this effect. This problem is common after an intervention performed if the user forgot that a pump management switch is in the forced operation position.

In the absence of the control box 40 in the monitoring device 20, step 52 can also compare the pressure in filter 30 with respect to an expected pressure in or outside of the recorded time slots of expected operation of the pump. If the control unit 21 detects that at least two consecutive measurements Mx are less than a minimum operating threshold value Pmin in a time slot of expected operation Prog, then the message 61 can also be transmitted to the user via the mobile application 22 in order to indicate that a suction valve is closed or a startup problem of the filtration pump. Conversely, if the control unit 21 detects that at least two consecutive measurements Mx are greater than a minimum operating threshold value Pmin outside of a time slot of expected operation Prog, then the message 61′ can also be transmitted to the user via the mobile application 22 in order to indicate that the filtration pump has started, characteristic of a pump management switch which has remained in forced operation position.

Step 53 carried out by the control unit 21 aims to detect whether the measurements Mx obtained during a predetermined time period exhibit an oscillating pressure profile. This oscillating profile can be characteristic of a low water level or of a blocked skimmer flap. Thus, a message 62 can be transmitted to the user if this situation is detected at the level in step 53.

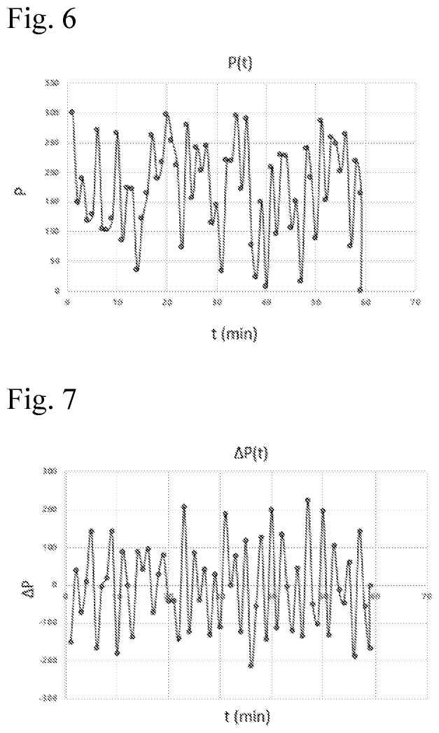

In order to detect this situation, for which a characteristic change of the pressure is illustrated in FIG. 6, it is possible to calculate pressure derivatives between two consecutive measurements Mx, as illustrated in FIG. 7. On the basis of these derivatives, an oscillating profile is identified when a predetermined number of derivatives exhibits sign reversal and a difference greater than a threshold value over a predetermined duration. For example, over a duration of 30 or of 60 min, it is determined whether at least 30% of the derivative measurements exhibit sign reversal with a threshold, between two measurements, greater than 20 mbars.

Step 54 enables one to detect a clogged prefilter or skimmer basket. For this purpose, another predetermined pressure profile is sought by the control unit 21 corresponding to a decrease of the pressure or an increase of the depression. More precisely, step 54 detects whether the measurements Mx obtained during a predetermined time period exhibit a decrease of the pressure which is rapid, for example, between 5 and 60 minutes, and continuous, for example, from 5 to 1000 mbar/minute, or an increase of the pressure which is rapid, for example, between 5 and 60 minutes, and continuous, for example, from 5 to 1000 mbar/minute. If such a predetermined pressure profile is detected, a message 63 indicating a clogged prefilter or skimmer basket is transmitted to the user.

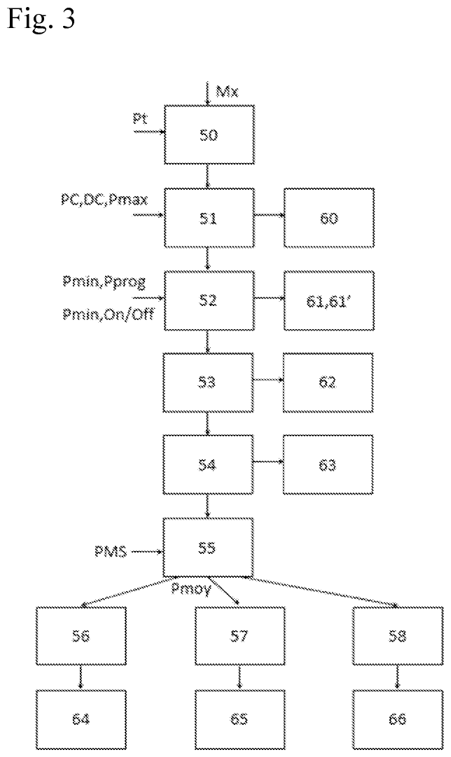

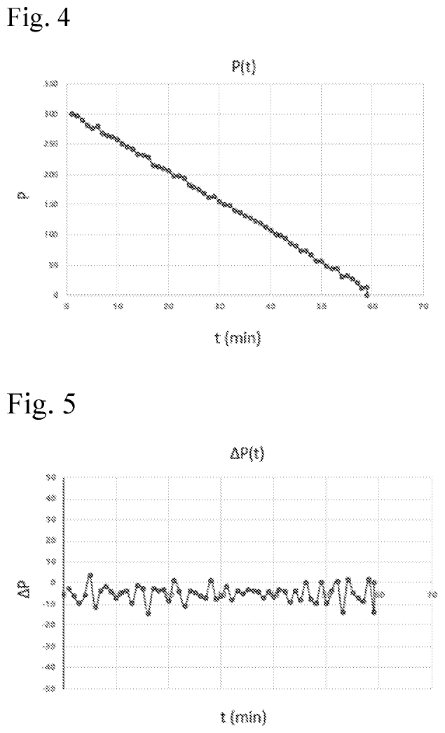

In order to detect this situation, for which a characteristic change of the pressure is illustrated in FIG. 4, it is also possible to calculate pressure derivatives between two consecutive measurements Mx, as illustrated in FIG. 5. On the basis of these derivatives, a decrease or increase profile is identified when a predetermined number of derivatives is less than or greater than a present threshold value. For example, over a duration of 30 or of 60 min, it is determined whether at least 90% of the derivative measurements are below a threshold of 0 bar.

Thus, signal processing operations can be used on the measurements Mx. FIGS. 4, 6 and 8 illustrate the measurements Mx obtained in steps 52, 53 and 54, respectively, over the same period of 60 min. These measurements correspond to pressure differences of 300 mbars to 0 bar due to different events during the suctioning of the pump but they nevertheless have identical slopes. Therefore, the instantaneous character of the measurements Mx must be considered by the remote control unit 21. For this purpose, the control unit 21 uses signal processing algorithms on the measurements Mx obtained in order to identify the malfunctions and generate the correct alert messages. Naturally, the examples described and the values indicated are only given as an indication and have no limiting effect. It is important to note that the malfunctions of a swimming pool monitored by the device 20 can be identified by the analysis of the pressure measurements in the filtration system alone.

Moreover, a neural network can also be used in the control unit 21 in order to search for possible malfunctions of the filtration system as a function of typical malfunction scenarios used to train the neural network.

After step 54, step 55 enables one to calculate a smoothed average pressure Pmoy, and this average pressure Pmoy can then be used in step 56 to calculate a level of clogging by dividing this average pressure Pmoy by the expected maximum service pressure PMS in the filter 30. Step 64 thus makes it possible to transmit to the mobile application 22 a level of clogging over time as a function of this calculation between the average pressure Pmoy and the maximum service pressure PMS. Moreover, step 57 makes it possible to detect a need for cleaning when the average pressure Pmoy is greater than the maximum service pressure PMS. If this is the case, a message 65 is transmitted to the user to indicate that the filter medium should be cleaned.

Moreover, if the average pressure Pmoy is less than the maximum service pressure PMS and greater than a predetermined percentage of this maximum service pressure PMS, for example, greater than 90% of the maximum service pressure PMS, calculated in step 58, a message 66 is transmitted to the user to warn him/her that a cleaning of the filter medium will soon be necessary. In this case, the message 66 constitutes a preliminary alert.

All these interpretation steps 50-58 can be carried out simultaneously and in parallel by the control unit 21 in order to enable multiple interpretations 60-66 of the measurements Mx. Moreover, the user can have the possibility of modifying the analysis scenarios via the mobile application 22 in order to improve the home automation applications, for example, by selecting the signal processing algorithms which are used from the algorithms proposed to the user.

In addition to the elements of the monitoring device 20 which are illustrated in FIG. 2, other connected elements can also be added in order to improve the automation functions. For example, the pump and the 6-way valve can be automated and controlled by the control box 40.

The user can thus leave it up to the control box 40 to choose to automatically cut or not the power supply to the filtration pump in the case of a malfunction that could jeopardize the operational reliability or the integrity of the filtration system, without the user having to physically go to the site to switch on its safety system.

Moreover, a sensor of the pH and/or the temperature of the water of the swimming pool can also be connected to the control unit 21 via the network gateway 24 in order to increase the automation possibilities, in particular the automatic control of the filtration system or its frost protection.

In general, the remote control unit 21 is a means of aggregation of the measurements Mx provided by different devices and sensors connected to the monitoring device 20, such as temperature sensor, pH sensor, ORP or redox sensor, pressure sensor, “ON/OFF” status of the pump control by the control box 40, etc.

For example, the filtration period of the pump can then be matched to the temperature of the water, and the messages transmitted to the user can also warn of an excessive variation of the pH.

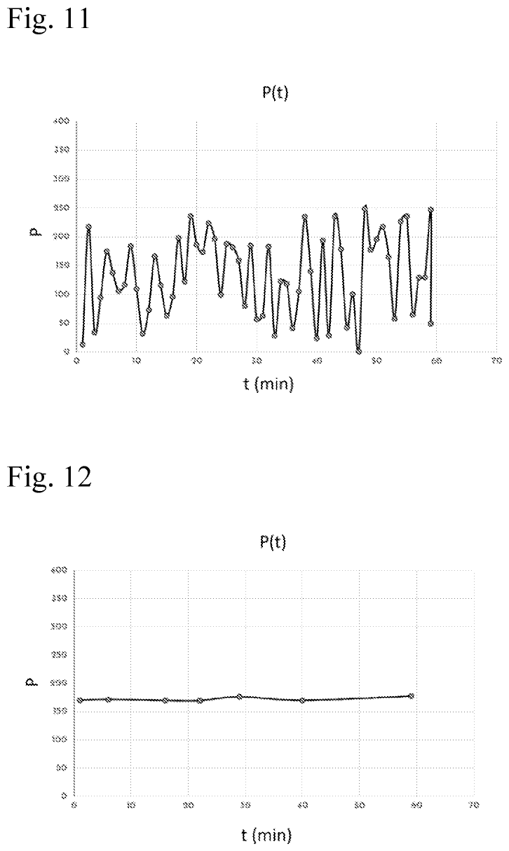

Moreover, the filtration pumps of certain swimming pool filtration units can create periodic oscillations of the precision measured by the wireless pressure sensor 10 of the invention and disturb the measurements or the interpretation. Such pressure variations are illustrated in FIG. 11 as examples.

In order to remedy this problem, it is possible to digitally process the measurement signal of the pressure sensor, for example, by carrying out the acquisition of each measurement by averaging several signals coming from the wireless pressure sensor 10.

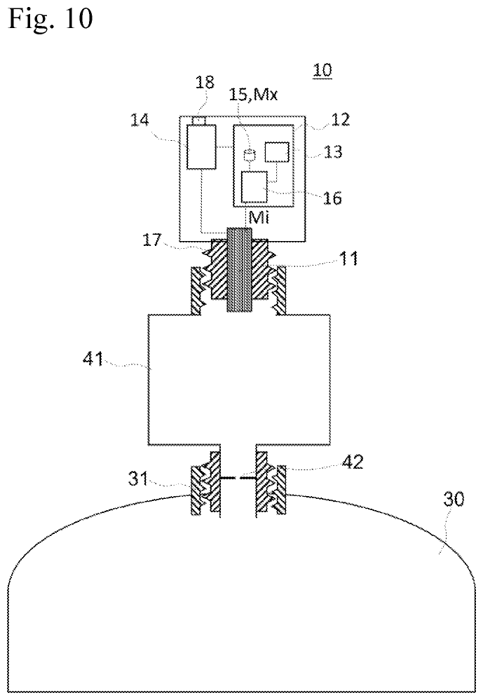

In a variant, it is possible to treat the periodic oscillations of the measured pressure by mechanical means. For this purpose, the device can comprise a buffer chamber 41 as illustrated in FIG. 10. This buffer chamber 41 has, for example, an internal volume filled with air.

The buffer chamber 41 can have any known shapes; it can be cylindrical, parallelepipedal, conical . . . . For example, the buffer chamber 41 is cylindrical and has a diameter of 20 mm, a height of 200 mm for a volume of 60 cm³. Naturally, the dimensions and the volume of the buffer chamber 41 can vary without changing the invention.

The buffer chamber 41 has a lower opening surrounded by lower fastening means and an upper opening surrounded by upper fastening means. A diaphragm 42 is preferably arranged in the lower opening. The lower fastening means comprise an external threading which matches the internal threading of the fastening means 31 of the filter 30, and the upper fastening means comprise an internal threading matching the external threading of the fastening means 17 of the sensor 10. Thus, the buffer chamber 41 can be mounted between the filter 30 and the sensor 10 and limit the pressure variations, as illustrated in FIG. 12.

The invention can thus provide a wireless pressure sensor 10 which is easy to install on a swimming pool filter 30 and enables one to control a large number of malfunctions that can be detected by the analysis of the pressure alone, all with a low quantity of consumed energy and stored data.

Thus, the energy storing element 14 can have great autonomy with the energy saving strategies implemented in the wireless pressure sensor 10 and a reduced impact in the remote storage spaces.

The invention also makes it possible, by means of the control box 40 connected to the control unit 21, to automatically secure the filtration system and the pump as soon as the pressure sensor 10 detects a critical behavior. Thus, a reactive and autonomous solution for securing the filtration system of a swimming pool is provided.

The present invention is naturally not limited to the described embodiment examples but instead extends to any modification and variant obvious to a person skilled in the art and within the limit of the appended claims. In addition, all or some of the technical features of the different aforementioned embodiments and variants mentioned above can be combined with one another. For example, the processing steps of FIG. 3 can be implemented in part and executed sequentially or in parallel.

1. A wireless pressure sensor of a swimming pool filtration system, said wireless pressure sensor comprising:
a pressure switch configured to measure a pressure and/or depression;
a communication unit comprising wireless communication means for transmitting the measurements of said pressure switch; and
an energy storage element configured to power said communication unit;
wherein said communication unit also comprises:
a memory for recording multiple consecutive measurements; and
an analysis device configured to detect a critical situation if one or more current measurements exceed a critical pressure value and/or a critical depression value and/or if the pressure difference between a current measurement and the last measurement recorded in the memory is greater than a predetermined value;
said communication unit being configured to send, upon expiration of a transmission period, the measurements stored in said memory;
said communication unit also being configured to transmit the measurements stored in said memory before the expiration of said transmission period when said analysis device detects a critical situation.

2. The wireless pressure sensor according to claim 1, wherein said analysis device is also configured to inhibit the recording of a current measurement if the difference between the current measurement and a preceding measurement is less than a recording threshold value.

3. The wireless pressure sensor according to claim 1, wherein said wireless communication means are configured to use the Lora communication protocol.

4. The wireless pressure sensor according to claim 1, wherein said transmission period is between 10 and 120 minutes.

5. The wireless pressure sensor according to claim 1, wherein said pressure switch is configured to measure a pressure and/or a depression with a refresh period between 1 second and 10 minutes.

6. A swimming pool monitoring device comprising:
a wireless pressure sensor according to claim 1; mounted on a filter or a pipe of a filtration unit;
a remote control unit, connected with said wireless pressure sensor and the internet network, configured to receive and interpret the measurements of said wireless pressure sensor;
a network gateway ensuring the communication of the data between said wireless pressure sensor and said remote control unit; and
a mobile application connected with said control unit so as to transmit the interpretations of said control unit to a user.

7. The device according to claim 6, wherein said control unit is configured to interpret a closed discharge valve when said control unit receives at least two consecutive measurements greater than or equal to a maximum operating threshold value.

8. The device according to claim 6, wherein said control unit is configured to interpret a closed suction valve or a startup problem of a filtration pump when said control unit receives at least two consecutive measurements which are less than a minimum operating threshold value in a time slot of expected operation.

9. The device according to claim 6, wherein said control unit is configured to interpret a startup of a filtration pump when said control unit receives at least two consecutive measurements which are greater than a minimum operating threshold value outside of a time slot of expected operation.

10. The device according to claim 6, wherein said control unit is configured to interpret a low water level or a blocked skimmer flap when the measurements obtained during a predetermined time period exhibit an oscillating profile.

11. The device according to claim 6, wherein said control unit is configured to interpret a clogged prefilter or skimmer basket when the measurements obtained during a predetermined time period exhibit a pressure decrease profile or a depression increase profile.

12. The device according to claim 6, wherein said control unit is configured to interpret a level of clogging of a filter medium by determining the ratio between a sliding average pressure value, calculated over a set of measurements obtained during a predetermined time period, and a maximum service pressure.

13. The device according to claim 12, wherein said control unit is configured to interpret a need for cleaning the filter medium when said average pressure value is greater than said maximum service pressure.

14. The device according to claim 12, wherein said control unit is configured to interpret a future need for cleaning the filter medium, when said average pressure value is greater than a predetermined percentage of said maximum service pressure.

15. The device according to claim 6, wherein said monitoring device moreover comprises a control box of the filtration pump, and wherein said control unit is configured to command said control box to cut the power supply to the filtration pump in case of a confirmed risk to the filtration system identified by said control unit on the basis of the measurements provided by the pressure sensor.

16. The device according to claim 15, wherein said control unit is configured to interpret a closed suction valve or a startup problem of a filtration pump if at least two consecutive measurements provided by the pressure sensor are less than a minimum operating threshold value and if the status of said control box indicates that it is operating.

17. The device according to claim 15, wherein said control unit is configured to interpret that the filtration pump has started, whereas the control box did not issue the command to that effect, if at least two consecutive measurements provided by the pressure sensor are greater than the minimum operating threshold value (P_{MIN}) and if the status of the control box indicates that it is not operating.

18. The device according to claim 6, wherein said device also comprises a buffer chamber mounted between the wireless pressure sensor and the filter or the pipe of the filtration unit.
